(19) United States
(12) Patent Application Publication
(10) Pub. No.: US 2008/0212444 A1
(43) Pub. Date: Sep. 4, 2008

(54) Multi Layer Record Carrier Comprising Compatibility Information and Method for Recording Such Compatibility Information on a Record Carrier.

(75) Inventors: Pope Ijtsma, Eindhoven (NL); Jakob Gerrit Nijboer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V, Eindhoven (NL)

(21) Appl. No.: 10/569,121

(22) PCT Filed: Aug. 25, 2004
(86) PCT No.: PCT/IB04/05163

§ 371 Date: Feb. 23, 2006

(30) Foreign Application Priority Data
Aug. 28, 2003 (EP) 03103240.2

(51) Int. Cl. G11B 3/74

(52) U.S. Cl. 369/94

(57) ABSTRACT

Multi layer record carrier comprising compatibility information, and method for recording such compatibility information on a record carrier.

The invention relates to a multi layer record carrier comprising at least two information layers for storing information. The invention relates especially to a dual layer recordable DVD disc. The invention further relates to a method for recording such a record carrier.

After recording information on a dual layer recordable DVD record carrier special actions need to be taken to make the record carrier compatible with existing playback devices. When a recordable DVD record carrier has to be made DVD-ROM compliant such that the recordable DVD record carrier can be played back in any DVD-ROM player, any unwritten areas need to be filled with dummy data because most DVD players cannot cope with a record carrier on which an information layer opposite to the information layer holding information is not written with any information.

The total space available for storing user information on a dual layer OTP-type (Opposite Track Path) DVD record carrier (recordable, rewritable, as well as read-only discs) is dependent on the location of a so-called middle zone on the information layers. This middle-zone is located at the transition from a first information layer to a second information layer. When the amount of information to be written is known on forehand, the location of the middle zone can be decided prior to writing. The location of the middle zone is then preferably selected such that substantially the same amount of information is written on both information layers.

However, when information of a previously unknown size has to be written on a dual layer recordable DVD record carrier, the location of the middle zone should preferably be placed at the maximum allowed position, which results in a maximum storage space. A downside of placing the middle zone at the maximum allowed position is the amount of time the filling with dummy data may take. This because any available storage space not written with user information has to be filled with dummy data.

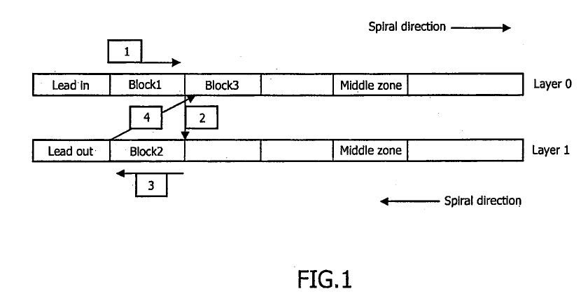

Pending European Patent Applications EP03103210.5 (PHNL031042) and EP03103217.0 (PHNL031046) describe methods of arranging the information on a multi layer record carrier such that the amount of time required for making the record carrier compatible with existing playback devices, especially with DVD-ROM players, is reduced to a minimum, without prior knowledge of the amount of information that should be stored. In these methods the information is distributed over the information layers of the multi layer record carrier according to a specific filling pattern during the recordings. By using such a specific filling pattern the amount of time required to close/finalize a session or disc, during which the dummy data is written, is significantly reduced. In these described methods, recording is switched from a first layer of the disc to a second layer of the disc each time a predefined amount of storage space is filled. This is schematically shown in FIG. 1, where paths 1 and 3 indicate write sequences, and paths 2 and 4 indicate layer jumps. A dual layer disc, as shown in FIG. 1, comprises two information layers, generally referred to as the Layer 0 (L0) and Layer 1 (L1). Layer 0 is the information layer located closest to the side of a disc where a radiation beam, such as a laser beam, used for reading and/or recording the information enters the disc. The drive initially writes a predefined amount of information (block 1) to Layer 0 (L0) and then switches to Layer 1 (L1) to write the next predefined amount of information (block 2). Next, the drive jumps back to Layer 0 to record in the predefined amount of storage space (block 3) behind the previously recorded block 1.

However, it is a problem that a multi layer disc recorded according to the above methods cannot be read without problems by any drive on the market today.

It is an object of the present invention to provide a multi layer record carrier that can be read by any drive, while it is still recorded according to the above-mentioned methods.

It was noted that record carriers recorded according to the above-mentioned methods have a logical block sequence that differs from a logical block sequence present on normal dual layer DVD-ROM discs. Newly developed drives for reading DVD discs recorded according to the above-mentioned methods, especially DVD+R dual layer drives, can be adapted to compensate for this different sequence. However, legacy drives, like for example existing DVD-ROM drives, will, in general, not be able to read without any problems these record carriers recorded according to the above-mentioned methods. According to the present invention, the record carrier comprises a special first session which is recorded such that it is readable by any legacy drive, and which special first session comprises special information to allow any legacy drive to subsequently read the entire record carriers recorded according to the above-mentioned methods.

This special first session may be prerecorded on the record carrier during manufacture, or may, alternatively, be recorded on the record carrier during a first time use of the record carrier.

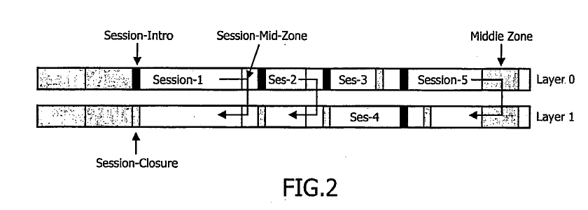

Next, the invention will be explained in more detail with reference to FIG. 2, which shows an embodiment of a record carrier according to the present invention. The record carrier shown in FIG. 2 comprises two information layers (Layer 0 and Layer 1). A special first session (Session-1) is recorded on information layer Layer 0, while the area on information layer Layer 1 opposite to the area holding Session-1 on information layer Layer 0 is written with dummy data Alternatively, a first part of the special first session (Session-1) is recorded on information layer Layer 0 and a second part of this special first session is recorded on layer Layer 1, while any possibly remaining storage space on information layer Layer 1 up to the Session-Closure is written with dummy data. Such special first sessions are readable by legacy drives.

Preferably, the special first session has a small size, for example 2 Mbytes, as not to decrease the storage space available to the user too much.

In an embodiment of the invention, the special first session (Session-1) contains a message that informs the user that the disc is a special DVD+R dual layer disc. This massage may further contain instructions on how the user information could be read from this record carrier. The message may, for example, be in the form of a text-file or of a HTML-file that can, for example, be launched by an autorun file.

In an embodiment of the invention, a filter drive (often referred to as a “driver”) is stored in the special first session (Session-1). To achieve read support on legacy drives this filter drive can be read from the record carrier and subsequently be used to perform a translation of a Logical Block Address (used by an application) to the corresponding Physical Block Address (as stored on the record carrier) and to the appropriate information layer. Such a translation is required because the relation between Logical Block Addresses and Physical Block Addresses on a record carrier written by the methods as described in Pending European Patent Applications EP03103210.5 (PHNL031042) and EP03103217.0 (PHNL031046) differs from that on standard dual layer ROM record carriers. Now, when such a filter drive (i.e., a driver) is used, the record carrier according to the invention will appear to a legacy drive to be a standard dual layer ROM record carrier. Alternative to storing the filter drive (i.e., the driver) in the special first session on the disc itself, the special first session contains a pointer to a location where such a filter drive is available. For example, the special first session may contain a HTML-file providing a webs link for downloading the filter drive (i.e., the driver) from the internet.

It is noted that newly developed drives which are adapted to compensate for the different sequence of blocks on the record carrier, and therefore do not require this special first session, may be adapted to hide the special first session so that the messages do not become visible and/or no filter drive (i.e., driver) will be (downloaded and) installed.

1. Multi layer record carrier comprising at least two information layers for storing information, user information being recorded on the record carrier in parts, which parts are alternately recorded on said at least two information layers, the record carrier comprising a part (special first session) which contains special information, said special information allowing the user information to be read from the record carrier.

2. A multi layer record carrier according to claim 1, wherein the special information comprises a filter drive (driver) for translating Logical Block Addresses into Physical Block Addresses.

3. A multi layer record carrier according to claim 1, wherein the special information comprises a pointer to a location of a filter drive (driver) for translating Logical Block Addresses into Physical Block Addresses.

4. Method of recording information on a multi layer record carrier comprising at least two information layers for storing information, user information being recorded on said record carrier in parts, which parts are alternately recorded on said at least two information layers, the method comprising an initial step of recording a part (special first session) containing special information, which special information allows the user information to be read from the record carrier.

5. A method according to claim 4, wherein the special information comprises a filter drive (driver) for translating Logical Block Addresses into Physical Block Addresses.

6. A method according to claim 4, wherein the special information comprises a pointer to a location of a filter drive (driver) for translating Logical Block Addresses into Physical Block Addresses.
